(19) United States
(12) Patent Application Publication
(10) Pub. No.: US 2016/0349973 A1
(43) Pub. Date: Dec. 1, 2016

(54) Video Messaging

(71) Applicant: Microsoft Technology Licensing, LLC, Redmond, WA (US)

(72) Inventors: Alan Wesley Peevers, Santa Cruz, CA (US); James Edgar Pycock, Palo Alto, CA (US)

(21) Appl. No.: 14/725,851

(22) Filed: May 29, 2015

(51) Int. Cl. G06F 3/0484; H04L 12/58

(52) U.S. Cl. CPC G06F 3/04847; G06F 3/04842; H04L 51/10; H04L 51/18

(57) ABSTRACT

A method of operating a first user terminal, the method comprising: determining a video clip to be communicated to a second user terminal; receiving a user selection from an end-user of the first user terminal, selecting a respective user-selected value for each of a user-controlled one or more of a plurality of controllable items of metadata for controlling playout of the video clip when played out at the second user terminal; and using a video messaging service to send a video message over a network to a second user terminal, the video message communicating the video clip and the respective user-selected values for the one or more user-controlled items of metadata, thereby causing the second user terminal to play out the video clip in accordance with the one or more user-controlled items of metadata.

### BACKGROUND

Various forms of messaging service are available, which allow an end-user running a client application on one user terminal to send a message over a network to another end-user running another instance of the client application on another user terminal. For example the network may comprise a wide-area internetwork such as that commonly referred to as the Internet. The client application at either end may run on any of a number of possible user terminals (not necessarily the same type at each end), e.g. a desktop computer or a mobile user terminal such as a laptop, tablet or smartphone; or may be a web client access from such terminals.

Messaging services include services such as IM (Instant Messaging) chat services. Although primarily designed for sending text-based messages, many IM chat services nowadays allow additional media to be sent as messages as well, such as emoticons in the form of short pre-defined animations, or user generated videos. E.g. the sending user may capture a video on a personal camera such as a webcam or smartphone camera, then drag-and-drop the video into the chat conversation or insert the video by means of some other intuitive user interface mechanism. Moreover, other types of messaging service also exist which support video messaging, such as dedicated video messaging services or multi-purpose messaging services. Hence media is increasingly sent during conversations as messages.

### SUMMARY

As well as user generated videos, it may be desirable if professionally created or centrally curated video clips can be made available for the sending user to use in to expressing him- or herself as part of a conversation conducted via a messaging service. For instance, instead of a conventional animated emoticon or a user-generated video message (filmed by an end-user, e.g. of him or herself, or his or her cat, etc.), it may be desirable to allow the user to instead insert a short video clip of, say, a famous line or scene from a popular film or TV program. In one implementation, to reduce transmission bandwidth, the sending user may send a video message which communicates a video clip by means of a link to a video clip stored on a central content storage service, causing the receiving user terminal to fetch the linked clip from the content storage service (over a network such as the Internet) and playout the fetched video clip to the receiving user.

On the other hand, even with such a system, it is recognized herein that different parties (other than the receiving user) may nonetheless still have different requirements or preferences as to the manner in which such content is played out at the receive side. For instance the sending user may wish to truncate the clip and have it loop through a specific part of the dialog, or the content owner may wish the content to be made available for video messaging only if it is displayed with certain call-to-action (CTA) text (“buy me now” or the like).

However, the content itself may be fixed or at least not easily modified, leaving little or no room for individual expression, or adaptation to the requirements of different parties. E.g. the content in question may be a movie clip of fixed length, which the video message communicates by linking to the published clip as stored in a central data store; in which case without putting further measures in place, the sending user has no control over the clip. One could potentially store a completely separate copy of the video clip for every possible variant that a user may happen to desire, but this would be wasteful of storage space and would soon become unwieldy as the number of variables grows. Alternatively one could allow the sending user terminal to download the video clip and then compose a completely new copy of the video clip by modifying the downloaded clip to include one or more user-specific modifications, but this would place an additional processing burden on the sending user terminal (and incur greater transmission bandwidth than the option of sending a link).

To address such considerations or similar, it would therefore be desirable to provide a mechanism allowing a sending user and/or content provider to control certain behavioural aspects of the playout of the video separately from the inherent content of the video itself. In fact, the applicability of such a mechanism is not limited to the case of centrally distributed or curated content; and even when where the video message is a user generated (e.g. by the sending user), it may still be desirable if the sending user is able to control the behaviour of the video clip after or independently of its filming. For instance, user generated content itself may be unloaded to cloud storage and made available for the sending user to send multiple times to different people, chats and at different times. In such cases it may be desirable to allow the sender to send the same item of user-generated content but with different behaviour or appearance on different occasions.

According to one aspect disclosed herein, there is provided a method of operating a first user terminal, as follows (e.g. performed by a communication client application run on the first terminal). The first user terminal determines a video clip to be communicated to a second user terminal (e.g. based on a selection by an end-user of the first terminal, such as a selection from amongst a plurality of videos stored on a central content storage service). The first user terminal also receives a user selection from the end-user of the first user terminal, selecting a respective user-selected value for each of a user-controlled one or more of a plurality of controllable items of metadata for controlling playout of the video clip when played out at the second user terminal. The first terminal then uses a video messaging service (e.g. IM chat service, multimedia messaging service or dedicated video messaging service) to send a video message to a second user terminal over a network (e.g. the Internet). The video message communicates the video clip and the respective user-selected values for the one or more user-controlled items of metadata, thereby causing the second user terminal to play out the video clip in accordance with said one or more user-controlled items of metadata.

For instance the video message may communicate the video clip by means of a link to the video content as stored in the centralized content storage service (rather than the clip being included explicitly in the video message). The second user terminal then downloads and plays out this centrally defined clip, but with the way in which the clip is played out adapted in accordance with the user-controlled metadata.

In embodiments, the controllable items of metadata, including at least one of the one or more user-controlled items of metadata, may comprise any one or more of: (a) an indication of whether or not to auto-play, (b) an indication of whether or not auto-play is to be silent, (c) an indication of whether or not to loop, (d) a start point within the video clip, (e) an end-point within the video clip, and/or (f) a degree of resizing. The start and/or end points (if used) could specify the start and/or end of a single play-through of the clip, or the start and/or end of the loop.

As another example the controllable items of metadata, including at least one of the user-controlled items of metadata, may further comprise metadata specifying one or more additional visual elements to be displayed in association with the playout of the video clip. These one or more additional visual elements may comprise any one or more of: (g) a mask, (h) a thumbnail or other placeholder image for display prior to play-out, (i) a placeholder image for display prior to the thumbnail, and/or (j) call-to-action text.

According to another aspect disclosed herein, there may be provided a system comprising: a messaging service for sending a video message from a first user terminal to a second user terminal via a network; a content storage service storing a plurality of videos, for supplying to a second user terminal a video clip selected by a user of the first user terminal from amongst said videos, based on a link received by the second user terminal in said video message; and a configuration service storing provider-specified values for each of a centrally-controlled one, some or all of a plurality of controllable items of metadata specified by a provider of said messaging service; wherein the configuration service is configured to supply the provider-specified values of the one or more centrally-controlled items of metadata to the second terminal, to thereby enable the provider to control the playout of said video clip by the second user terminal.

In embodiments, the content storage service and/or configuration services may be configured in accordance with any one or more of the features disclosed herein. For example the configuration service may allow the metadata to be managed independently of the videos in the content storage service. The configuration service may allow the provider specified values of the metadata to be varied over time while some or all of the videos, including said video clip, remain fixed (unmodified). The content service and configuration service may act as two separate tools, in that different groups of personnel are authorized to login to manage the video content and metadata respectively (either different employees of the same organization, or employees of different partnered organizations acting together as the provider).

In embodiments, for at least one of the controllable items of metadata, the respective user-specified value controls the playout by default if no respective provided-specified value is supplied by the configuration service, but otherwise the respective provider-specified value overrides the user-specified value. In embodiments, for at least one of the controllable items of metadata, the respective provider-specified value controls the playout if no respective user-specified value is communicated in the video message, but otherwise the respective user-specified value may override the provider-specified value.

According to another aspect disclosed herein, there may be provided a method of operating a second user terminal (e.g. performed by a communication client application run on the first terminal), the method comprising: receiving a video message from a first user terminal communicating a video clip, receiving values of one or more items of controllable metadata from the first user terminal and/or configuration service, and playing out the video clip in accordance with the received values of said one or more items of controllable metadata.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted in the Background section.

### BRIEF DESCRIPTION OF THE DRAWINGS

To assist understanding of the present disclosure and to show how embodiments may be put into effect, reference is made by way of example to the accompanying drawings in which:

FIG. 1 is a schematic block diagram of a communication system,

FIG. 2 is a schematic illustration of a video image,

FIG. 3 is a schematic illustration of a video image whose playout is controlled according to received metadata, and

FIG. 4 is another schematic illustration of a video image whose playout is controlled according to received metadata.

### DETAILED DESCRIPTION OF EMBODIMENTS

Media is increasingly sent during conversations as messages. As well as user generated media (e.g. his or her own videos or photos), professionally created content can be made available specifically to be sent as a form of personal expression, for example, emoticons, stickers, gifs and video clips. This media maybe professionally created and assembled as a selected and curated store of content that is presented to a user (for example, through a picker within a client app). While user generated content tends be unique (e.g. each video or photo taken is unique), professional media involves a file being made available to many users and sent many times in different conversations. As such professional media is often centrally stored in the cloud, and messaging involves sending a pointer (URL) to the location of the media file on cloud storage.

In addition to sending the media from one client to another (by means of a message that contains a pointer to where the media file exists in the cloud and can be retrieved for display), one may also wish to specify and vary how such media is presented rendered within an application. For example, it may be desired to enable movie clips to be sent from one client to another but for those clips to appear in the receiving client with a particular branded look and feel, and/or to be visually distinguishable from other types of video content, and/or to specify a particular behavior in the user interface. E.g. it may be desired that a movie clip is rendered within a shaped mask or frame (border) in order to indicated that it is a certain type of media (e.g. in a square mask with rounded corners) while another type of video is rendered with a different mask (e.g. a circular mask). Alternatively or additionally, it may be desired to specify whether a received media item automatically plays, whether it plays both video and audio, whether it plays once or loops, and/or whether additional text is displayed alongside the media such as attribution notices or web links off to other sites. While the media file maybe centrally stored in the cloud, the display of the media when received in a message may thus be locally created and controlled by the client application, or by centrally via a separate configuration service of the messaging.

The following describes how a message may contain both a reference to a cloud stored media item (such as a video clip) and additional separate data which specifies the desired presentation of that media item once received by a client (e.g. whether it is presented inside a mask or frame, whether it loops, whether additional text is displayed alongside it, etc.).

The disclosed techniques provide for the separation of media from media presentation data, where that presentation data may be obtained by the sender when selecting a media item (e.g. from a picker). The sending client generates a message which contains both (i) the URL reference to the cloud store location for the media item plus (ii) the metadata for specifying the display of the media (as described below, such display data maybe fully contained within the message body or itself sent in the message in the form of a URL reference to cloud-based display data, or a hybrid).

The data for specifying the display of the media item may be obtained by the sending client and sent as part of the message content (the payload) or, optionally, the display data may itself be cloud based and a reference to that data may be sent in the message. Either way, there are two forms of data, (i) the media file itself and (ii) metadata describing the desired display of that media, and these may be changed independently.

Embodiments allow for the combination and variation of approaches to meet different needs. For example, a given media file sent at one point in time may be displayed in a certain way but the same media file when received at a different time may be displayed differently because the metadata specifying how it is to be displayed has been changed. E.g. a video file may be shown with a snowflakes mask during December but the same video file shown with a sun mask during summer (note however, even though the display data has subsequently been changed, e.g. to specify a sun mask now rather than a snowflakes mask, the provider of the messaging service may not wish this change to apply to previously received instances of the media file—in other words, when a user scrolls back through his or her message history it may be arranged that the media is shown as it was shown at the initial time of receipt and not retrospectively changed just because its associated display data has now been changed).

As another example, the data for generating an immediate ‘placeholder’ display of the media could be actually contained within the body (payload) of the message, or pre-stored in the client application, ensuring that there is no delay retrieving data from the cloud. Alternatively interim display assets can be automatically downloaded before the main media item is. For example, a thumbnail image maybe retrieved from the cloud when the message is received and used to display inline in the conversation, while the full video file is not retrieved until a further user action triggers it, or until other conditions are met such as the user moving on to Wi-Fi, or simply because the full media asset (e.g. a video file) has not been downloaded yet due to its size.

As another example, display-related metadata can point to additional cloud resources to be used in the display of the media file. For example, the display data may specify a mask type but the mask file itself maybe cloud based (rather than hardwired into clients, or actually sent in the message).

Because the metadata to guide the display of the media is separate from the media file itself then clients can also locally apply their own decisions on media display. For example, a client might disable masks, looping, sponsor logos, or may allow users to set a setting to disable the display of any image content at all.

Clients may also optionally pass information specific to themselves (as the receiver) which instructs the cloud to transform the media file for their needs. Examples include changing the format and dimensions of a media file for different screen sizes and resolutions. Other examples include changing media according to the location or language preferences of the receiver. A further example includes cloud scaling of assets to accommodate changing network conditions (e.g. 2G to LTE or WiFi, etc.).

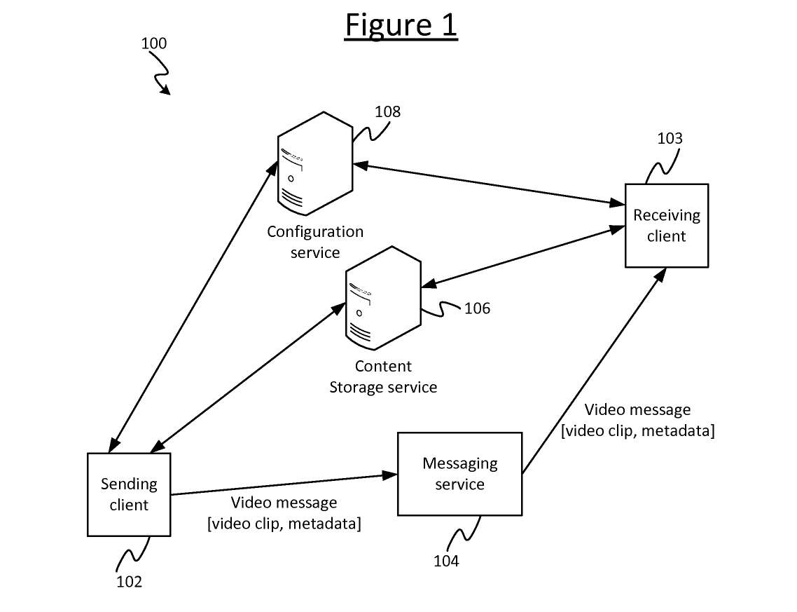

Examples such as these and others will now be discussed in more detail in relation to FIGS. 1 to 4.

FIG. 1 shows an exemplary communication system 100 in accordance with embodiments disclosed herein. The system 100 comprises a first user terminal 102, a second user terminal 103, and a messaging service 104, wherein the first and second user terminals 102, 103 are arranged to be able to communicate with one another via the video messaging service 104 and a network, e.g. the Internet (not shown). Each of the user terminals 102, 103 may take any suitable form such as a smartphone, tablet, laptop or desktop computer (and the two terminals 102, 103 may be the same form or different forms). Each of the user terminals 102, 103 is installed with an instance of a communication client enabling the user terminal to send and receive messages to and from other such terminals over a network using the video messaging service 104. It will be understood that any of the operations attributed below to the first and second user terminals may be performed under control of a first and second communication client application (or “app”) run on the first and second terminal 102, 103 respectively. On each user terminal 102, 103, the client may be implemented in the form of software stored on a memory of the respective terminal 102, 103 (comprising one or more storage devices) and arranged so as when on a processing apparatus (comprising one or more processing units) to perform the relevant operations. Alternatively one or more of the user terminals 102, 103 could be arranged to access a web-hosted version of the client in order to conduct the messaging. Either way, the client may be embodied on any suitable medium or media, e.g. an electronic medium such as an EEPROM (flash memory), magnetic medium such as a hard disk, or an optical medium; and may be run on a processor comprising one or multiple cores, or indeed multiple processor units in different IC packages.

The messaging service 104 may take any of a variety of forms such as an IM chat service with added video messaging functionality, or a dedicated video messaging service, or a general-purpose multimedia messaging service. The messaging service 104 represents a mechanism by which the first user terminal 102 can send a message to the second user terminal 103 over a network, or vice versa. The following will be described in terms of a message being sent from the first user terminal 102 to the second user terminal 103, but it will be appreciated that in embodiments the second user terminal 103 can use similar techniques to send a message to the first user terminal 102, or indeed to send messages between any combination of any two or more user terminals running the relevant client application (or accessing an equivalent web-hosted version of the client).

Note that the term “network” here covers the possibility of an internetwork comprising multiple constituent networks; an example being the Internet, or the Internet plus one or more other networks providing the user terminals 102 with access to the Internet. For instance, either of the first user terminal 102 and/or second user terminal 103 may connect to the Internet via any of: a wireless local area network (WLAN) such as a Wi-Fi, Bluetooth or ZigBee network; a local wireless area network such as an Ethernet network; or a mobile cellular network, e.g. a 3GPP network such as a 2G, 3G, LTE or 4G network. The following will be described in terms of the messaging service 104 providing for messaging over the Internet, but it will be appreciated that this is not necessarily limiting.

Note also that the video messaging service 104 in FIG. 1 may represent any of a variety of different communication mechanisms suitable for delivering messages over the Internet, or the like. The messaging service 104 may be implemented by means of a server of a centralized messaging service (the “server” being manifested as one or more physical server units at one or more geographic sites), or by means of a decentralized messaging service such as a peer-to-peer (P2P) based service. In either implementation, note that where it is said that messages are sent “via” or “by means of” the messaging service 104, or the like, this does not necessarily mean in all possible embodiments that the messages travel via a central server (though that is indeed one possible implementation). Instead the messages may be sent (over the Internet) directly between the clients running on the first and second user terminals 102, 103, in which case the messaging service 104 may represent the service created by the provision of client applications working together on the different user terminals 102, 103 plus any supporting aspect of the service, such as a centrally-implemented or distributed address look-up and/authentication service enabling the sending user to look up the network address of the receiving user terminal and/or ensure the second user's identity is authenticated. Nonetheless, in preferred embodiments the messaging service 104 does indeed comprise a messaging server (implemented on one or more server units at one or more sites). In this case the client running on the first user terminal 102 sends a message destined for the second user terminal to the messaging service server, and this server delivers the message to the second user terminal. One consequence of this is it allows for messages to be held at the server in case the second user terminal is offline at the time of the message being sent—i.e. if the second user is offline, the sever 104 stores the message and attempts to re-deliver it again at one or more later times (e.g. periodically or when polled by the second user terminal 103).

By whatever means implemented, the messaging service 104 thus enables the first user terminal 102 to send a video message to the second user terminal 103. In embodiments the messages are sent as part of a conversation between at least a user of the first terminal and a user of the second terminal (and optionally other user of other terminals as well). A given conversation may be defined by a given session of the messaging service 104 established between the clients on the first and second terminals 102, 103; and/or by a given chain of conversation stored as a thread at the first terminal, second terminal 103 or messaging service server.

To facilitate the inclusion of video messages in a conversation, in embodiments the communication system 100 further comprises a content storage service 106 operated by a provider of the messaging service 104. The content storage service 106 comprises a content repository in the form of a server storing a plurality of items of media content, including at least a plurality of video clips (again the service may be implemented in one or more server units at one or more sites). The content storage service 106 also comprises a content management system (CMS), which is a tool enabling the provider to manage the content in the content repository (e.g. to add new clips, delete clips, and/or update clips).

By way of example, some or all of the clips may be short segments of famous films or TV programs, which include well-known lines aptly summarising experiences or emotions that the user may wish to communicate. The user of the first user terminal 102 can select a video clip from the store in the content storage service 106, and choose to send a message to the second user terminal communicating this video clip. The user can use thus use the clips from the content storage service 106 to express him or herself in a succinct, striking, and/or humorous fashion, etc. E.g. if circumstances have not turned out well for the user of the first terminal 102, he or she could include in the conversation a clip from a famous space movie, in which the occupants of a space craft inform mission control that they are experiencing difficulty. Or if the user has to leave the conversation but only temporarily, he or she could include a clip from a movie in which a famous robot announces that he shall return.

In order for the video message to communicate the clip, there are at least two options. The first option is for the first user terminal 102 to download the video clip from the content storage service 106 (via the Internet), or perhaps take a locally generated or locally stored video clip, and include this video clip explicitly in the video message itself. I.e. the message as communicated over the Internet from the first terminal 102 to the second terminal 103 directly includes the video clip (the actual video content) in its payload. However, this means the video message will tend to be very large in size. The full video image data of the video clip will have to be transmitted on the uplink from the first user terminal 102 (typically the uplink is more constrained than the downlink). Also, in the case where the first user terminal 102 downloads the video rather than using local content, this means the full video image data of the video clip has to be transmitted twice: once from the content storage service 106 to the first user terminal 102, and then again in the message from the first user terminal 102 to the second user terminal 103. This is wasteful. Furthermore if the message is to be pushed to the second user terminal 103, then the user of the second user terminal 103 does not have the choice as to whether to receive the whole video (e.g. perhaps the second user terminal 103 is currently only connected to the Internet by a slow or expensive cellular connection and does not want to receive video files, which can be quite large in size).

To address one or more such considerations, a second option therefore is for the video message to communicate the video clip not explicitly in the video message, but rather by including in the video message a link (pointer) to the video clip as stored in the content storage service 106. When the second user terminal 103 then receives the video message, it reads and follows the link, thus causing it to download the messaged clip from the content storage service 106 and plays it out through the front-end of the client application as part of the conversation between the users of the first and second terminals 102, 103. This could happen automatically upon receipt, or alternatively the user of the second terminal 103 could be prompted to confirm whether he or she wishes to download the video.

The above discussion so far in relation to FIG. 1 describes a basic video messaging service. However, while the video clips add an extra form of expression for the users beyond a basic IM messaging service, there is still a certain lack of flexibility in that the video content itself is a fixed resource. Following from this observation, it is recognized herein that there are aspects of the video other than the raw video content of the video itself that might be controlled separately or independently of the video content, e.g. temporal aspects such as whether the video clip is to loop when played out at the second user terminal 103, whether the video clip is to auto-play when played out at the second user terminal 103, a start time within the clip at which to begin the playout or loop, and/or a stop time within the clip at which to end the playout or to define the end of the loop. Another example would be the selection of a certain graphical mask, such as rounded corners to indicate a clip from a TV show or a movie reel border to indicate a movie clip.

For instance, providing this mechanism may allow a variety of different variants of each video clip to be created without having to store a whole extra video file at the content storage 106 for each variant. Also, the actual video data content of the video clips themselves may be fixed or at least not readily modified. Therefore by associating separately controllable metadata with the clips, the behaviour or appearance of the playout of the video can be varied over time while the underlying video clip itself remains unchanged in the content storage service 106.

Furthermore, while the underlying video content of the clips remains constant or under the control of a curator of the content storage system 106, control of the additional behavioural or display related aspects may be given to a person who is not allotted the responsibility of curating the content in the content storage service 106, e.g. the sending end-user, or an employee of the messaging service who is allowed some responsibility but not the responsibility for curating actual video content.

Therefore according to embodiments disclosed herein, in addition to communicating the video clip, the video message from the first (sending) user terminal 102 further contains one or more fields communicating metadata associated with the video clip; where the metadata has been chosen separately or independently of the selection of the video clip (even if the user makes the selection because he or she feels that a certain metadata effect would go well together with a certain clip, the selection is still independent in a technical sense in that the system 100 allows the two selections to be varied independently of one another, and in embodiments does not in any way constrain the selection of the one based on the selection of the other or vice versa).

Alternatively or additionally, some or all of the metadata may be supplied to the second user terminal 103 from a configuration service 108 run by a provider of the messaging service 104. In this case, the configuration service 108 takes the form of a server storing values of the metadata for supply to the second terminal 103. Again, this server may comprise one or more physical servicer units at one or more geographical sites. Note also that the server unit(s) upon which the messaging service 104, content storage service 106 and configuration service 108 are implemented may comprise one or more of the same unit(s), and/or one or more different units. Further, note that where it is described herein that the content storage service 106 and/or configuration service 108 are provided, operated or managed by a provider of the messaging service 104, or such like, this does not exclude that the provider is formed by multiple parties working in collaboration. E.g. the provider may comprise a first organization such as a VoIP provider that has expanded into video messaging, partnering with a media production or distribution company; in which case the first organization may operate the server associated with the basic messaging functionality (e.g. acting as an intermediary for the messages, or providing for address look-up); while the media production or distribution company may run the content storage service 106; and either or both parties, or even a third party, may run the configuration service 108. In such cases the parties may be described jointly as the provider of the messaging service in that together they provide the overall functionality of enabling end-users to send video messages in order to communicate video clips. Alternatively all of the basic messaging, the content storage service 106 and the configuration service 108 may be run by the same party, e.g. the VoIP provider. In general the provider of the messaging service 104 may comprise any one or more parties (other than pure consumers, i.e. other than the end-users of the first and second terminals 102, 103) who contribute to the provision of the video messaging mechanism, video clip content and/or metadata which together form the overall messaging service.

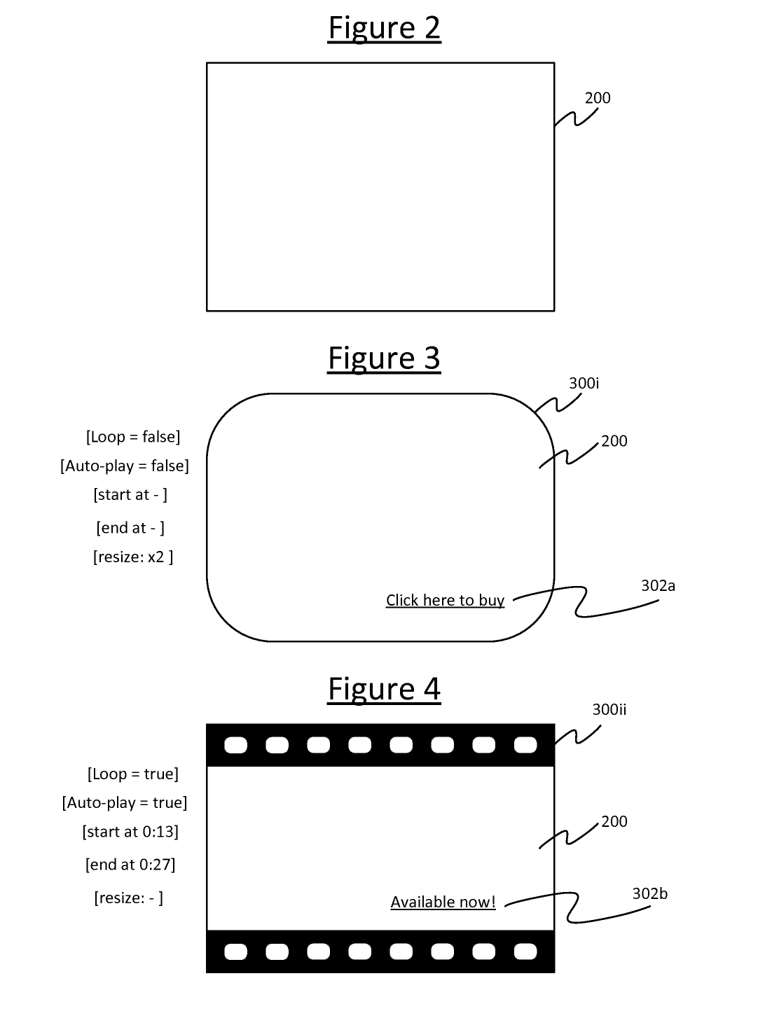

Methods of delivering the metadata to the second user terminal will be discussed in more detail shortly, but first some types of metadata are exemplified with reference to FIGS. 2 to 4.

FIG. 2 illustrates schematically a video clip 200 as stored in the content storage service 106. The video clip 200 comprises data representing a sequence of images (video frames), and has a certain inherent shape, size and duration; all of which are fixed, or at least not convenient or indeed desirable to change. The second user terminal 103 receives a video message from the first terminal 102 communicating this video clip, either by means of a link or explicitly, as discussed above. However, rather than playing out this video clip with the exact imagery, shape, size and/or duration as specified inherently in the video clip itself, the second user terminal 103 is controlled by metadata received in the message or from the configuration service 108 to adapt the appearance or behaviour with which the video clip is played out as specified by the metadata.

The following sets out some exemplary items of metadata that may be controllably associated with a video clip in accordance with embodiments of the present invention. In any given implementation, any one, some or all of these types of metadata may be used. Examples are illustrated in FIGS. 3 and 4.

A first category of metadata is appearance-supplementing metadata that associates one or more additional graphical elements with the clip. This may for example include an indication of what mask 300 or frame (border) to use, if any. As will be understood by a person skilled in the art, a mask is a graphical element that overlays and/or removes certain areas of the video clip, but not others. For instance FIG. 3 shows a mask 300i giving the video clip rounded corners, to give the appearance of an old-fashioned TV screen. E.g. the user of the first terminal 102 may select this as a way of indicating to the user of the second terminal 103 the fact that the clip is from a TV show. FIG. 4 shows a mask 300ii superimposing a movie reel effect over the video clip. E.g. the user of the first terminal 102 may select this as a way of indicating to the user of the second terminal 103 the fact that the clip is from a movie.

Another type of metadata that may be included in this category is call-to-action (CTA) text 302, i.e. a textual message plus associated URL address which the receiving user terminal 103 navigates to when the message is clicked or touched. E.g. an owner of the video content may only allow the clip to be used for this person, or may allow it with a recued license, if the clip is superimposed or otherwise accompanied by a selectable message such as “click here to buy” (302a) or “available now” (302b) which the user of the receiving user terminal 103 can click (or touch) to buy the full move or TV show from which the clip is taken.

Another type of metadata in this category is an indication of a representative frame to use as a thumbnail, or indeed another placeholder image to use as a thumbnail. This provides second user terminal 103 with a still image to displayed in place of the video clip while waiting for it to download from the content storage service 106 or messaging service 104. E.g. the thumbnail may be a representative frame of the video clip, or an icon indicating a movie. In embodiments, the thumbnail may be included explicitly in the video message while the video clip is communicated by means of a link to the content storage service system 106, and the second terminal 103 may use the thumbnail to display in place of the video clip while it fetches the clip from the content storage service 106. Alternatively the thumbnail could also be communicated by means of a link sent in the video message (e.g. “use frame n as the thumbnail”), and the second user terminal 103 downloads the thumbnail first before the rest of the movie clip. E.g. the thumbnail may also be stored in the content storage service 106, or may be stored in the configuration service 108.

There may even also be indicated a simple placeholder graphic to be displayed while the second user terminal 103 fetches the thumbnail. E.g. the placeholder graphic may be included in explicitly in the video message, while the clip is communicated by means of a link to the content storage service 106, and to communicate the thumbnail the video message also includes a link to an image stored in the content storage service 106 or configuration service 108. In this case the placeholder graphic may be displayed in place of the thumbnail while the second user terminal 103 fetches the thumbnail from the content storage service 106 or configuration service 108, and the thumbnail is then displayed in place of the video clip while the second user terminal 103 fetches the clip from the content storage service 108.

A second category of metadata is metadata that does not provide any additional content per se (such as the video itself, thumbnails or masks, etc.), but rather specifies the manner in which video media is to be played out. This may include temporal aspects of the playout, such as: whether or not to auto-play the video clip upon receipt by the client running on the second user terminal 103, whether or not the auto-play should be silent, whether or not to loop the video when played out at the second user terminal 103, the ability to specify a start point within the video clip (later than the inherent beginning of the video clip), and/or the ability to specify an end point within the video clip (earlier then the inherent end of the video clip). Note that start and/or end points (if used) could specify the start and/or end of a single play-through of the clip, or the start and/or end of the loop. There even be separate settings for the start and end points of the loop, so potentially up to four parameters: startFrame, endFrame, loopStart, loopEnd (though in embodiments loopEnd might obviate endFrame).

Another example of metadata in this category is an indication of a degree to which to resize the video clip, i.e. the degree to which to magnify or demagnify (shrink) the clip—i.e. increase or decrease its apparent size, or zoom in or out. E.g. this could comprise an indication to resize by a factor of ×0.25, ×0.5, ×2 or ×4, etc. and/or an indication as to whether to allow full screen playout.

A third category of metadata defines one or more rules specifying how the playout of the video clip is to be adapted in dependence on one or more conditions to be evaluated at the second user terminal 103 (If . . . then . . . , if . . . then . . . , etc.). For instance, the one or more conditions may comprise: a quality and/or type of network connection used by the second user terminal to receive the video clip. E.g., using this mechanism, the playout may be made to depend on what type of network is being used by the second user terminal 103 to connect to the Internet and to thereby receive the video clip—such as whether a mobile cellular network or a LAN, whether usage of that network is metered or unmetered, or in the case of a mobile cellular network whether the network is 2G, 3G, LTE or 4G, etc. This type of metadata may be linked to one or more other items of metadata in the other categories, e.g. whether to auto-play. For instance the rule-defining metadata may specify that auto-play is allowed if the second user terminal 103 currently has available a Wi-Fi or other LAN connection to the Internet, but not if it only has available a cellular connection; or auto-play is only allowed if the second user terminal 103 has an LTE connection or better. Or auto-play may only be allowed if the second terminal's connection to the Internet exceeds a certain quality threshold, such as a certain available bitrate capacity, or less than a certain error rate or delay.

N.B. in all cases, the metadata of the present disclosure is not metadata that is added to the video file at the time of capture by the video camera. Nor is it metadata that simply describes the inherent properties of a video, but rather which controls the way in which it is played out. E.g. if the metadata specifies resize ×4, this is not there to inform the receiver 103 what size the video is, but rather to instruct the receiver to take a video clip having some pre-existing size and magnify it to change its displayed size. Or if the metadata specifies a playout start and/or end time, this does not simply describe the length of the video clip, but rather tells the receiver to take a video clip of a pre-existing length and truncate its length according to the specified start and/or end time.

As mentioned, the metadata may originate from the first (sending) user terminal 102, or from the configuration service 108. The metadata may be selected by the end-user of the first terminal 102 and communicated to the second user terminal 103 by means of the video message, or it may be selected by a provider operating the configuration service 108. The metadata may also be a combination of these, i.e. some from the first user terminal 102 and some from the configuration service 108, and/or some selected by the end-user of the first user terminal 102 and some selected by the provider.

In the case where some or all of the metadata is selected by the user of the first (sending) user terminal 102 and communicated to the second user terminal 103 in the video message, this allows the end-user at the send side to control how the video will appear or behave at the receive side (despite the fact that he or she does not have control over the actual video clip content stored in the central content storage service 106). To do this, some or all of the metadata may be included explicitly in the video message sent from the first user terminal 102 (the metadata need not be very large). Alternatively, the metadata may be communicated by means of a link included in the video message, linking to actual values for the metadata stored in the configuration service 108 or content storage service 106. For example, certain templates could be included in the configuration service 108 or content storage service 106 (e.g. template A is the combination of metadata shown in FIG. 3, and template B is the metadata combination of FIG. 4), and the video message may link to a certain specified template. Alternatively, a certain set of metadata preferences could be stored under an online profile for the sending user, and the video message may instruct the receiving user terminal 103 to retire and apply the metadata preferences of sending user X when playing out the clip.

In the case where some or all of the metadata is specified by a provider of the messaging service, this originates from the configuration service 108 (via the Internet). For example, in embodiments the client on the second user terminal 103 is configured to automatically poll the configuration service 108, either repeatedly (e.g. regularly such as every 10 minutes) or in response to a specific event such as when a new video message is received. In response, the configuration service 108 returns the latest values for the items of metadata in question. This way, as the configuration service 108 is a separate store of data that can be independently modified, this allows the provider the ability to vary the appearance or behaviour of the video clips without having to actually modify the underlying content in the content storage service 106. For example, the provider could update some aspect of the metadata over time while the actual video clips in the content storage service 106 remain fixed. E.g. the provider could specify that clips are shown with a snow scene mask on December 25 or a certain range of days during winter, while clips are shown with a sunshine mask on a summer public holiday or a certain range of days during summer, etc.

From wherever it originates, the metadata (mask, CTA text, etc.) is combined with the video clip at the receiving user terminal 103. E.g. the receiving terminal 103 receives the mask in the metadata, or receives a link to a mask as stored in the configuration service 108 or content storage service 106, and also receives a link to a video clip in the content storage service 106. Based on the mask and clip as received at the receiving user terminal 103, the receiving (second) user terminal 103 then composes the video to be played out to the user (e.g. as shown in FIG. 3 or 4). Thus the metadata may be applied at the receiving terminal: e.g. in the case of a mask, the location of the mask is obtained from metadata; and the receiving client fetches the mask, similarly to how it fetches the video, and applies the fetched mask locally.

Alternatively, some or all of the metadata could be combined with the video clip in the cloud, e.g. in the content storage service 106 or configuration service 108. For example in response to the video message, the second (receiving) terminal 103 may instruct the content storage system 106 to fetch the linked-to metadata from the configuration service and combine with the linked-to video clip in the content storage service 106, then return the resulting composite video clip to the second user terminal 103 for play-out. Or conversely, in response to the video message, the second (receiving) terminal 103 may instruct the configuration service 108 to fetch the linked-to video clip from the content storage service 106 and combine with the linked-to metadata in the configuration service 108, then return the resulting composite video clip to the second user terminal 103 for play-out. Such arrangements would allow senders to specify that algorithms or other metadata be applied in the cloud service to the video clips before being delivered to the recipients. Such algorithms could be similar to, but potentially far more versatile than, masks. E.g. by providing a facility to apply filter X to clip Y, this allows X*Y unique experiences to be realized by recipients.

Turning now to the nature of the content storage service 106 and configuration service 108, these take the form of two separate tools, which may have different front-ends with different available controls and appearances. In embodiments, they both also require an authorized employee of the provider to login in present credentials, and thereby be authenticated, in order to be able to manage the video clips and metadata respectively; the configuration service 108 is set up to recognize a different group of employees as being authorized to login than the content storage service 106 (either different employees of the same organization, or employees of different partnered organizations where such organizations act together as the joint provider). Thus the curation of the content and the management of the metadata are kept in two separate domains, and therefore again are made independent of one another.

In embodiments the configuration service 108 also enables different values of one or more of the items metadata to be specified for different geographic regions (e.g. different countries) or different subgroups of users. In this case the second user terminal 103 automatically detects its country and/or user group and queries the configuration service 108 for the relevant version of the metadata, or the configuration service 108 detects its country and/or user group and queries the configuration service 108 for the relevant version of the metadata.

Note: as values for metadata may be specified by the video message and by the provider, this creates the possibility that for at least one item of metadata, the second user terminal receives both a respective user-selected value and a provider-specified value. Thus in embodiments, the client on the second user terminal 103 is configured to recognize a priority of one over the other. I.e. in embodiments, for at least one of the controllable items of metadata, the second user terminal 103 uses the respective user-specified value to control the playout by default if no respective provided-specified value is supplied by the configuration service, but otherwise the respective provider-specified value overrides the user-specified value. In embodiments, for at least one of the controllable items of metadata, the second user terminal 103 uses the respective provider-specified value to control the playout if no respective user-specified value is communicated in the video message, but otherwise the respective user-specified value overrides the provider-specified value. The priority of one type of value over the other may be applied on a per item basis (i.e. for some metadata the user-specified values override the provider-specified values and vice versa for other metadata), or alternatively a blanket policy may be applied (i.e. either the user specified values always override the provider's values, or vice versa).

It will be appreciated that the above embodiments have been described only by way of example. Other variants may become apparent to a person skilled in the art given the disclosure herein. The scope of the present disclosure is not limited by the particular described examples, but only by the accompanying claims.

1. A method of operating a first user terminal, the method comprising:
determining a video clip to be communicated to a second user terminal;
receiving a user selection from an end-user of the first user terminal, selecting a respective user-selected value for each of a user-controlled one or more of a plurality of controllable items of metadata for controlling playout of the video clip when played out at the second user terminal; and
using a video messaging service to send a video message over a network to a second user terminal, the video message communicating the video clip and the respective user-selected values for the one or more user-controlled items of metadata, thereby causing the second user terminal to play out the video clip in accordance with said one or more user-controlled items of metadata;
wherein the controllable items of metadata, including at least one of the one or more user-controlled items of metadata, comprise any one or more of:
an indication of whether or not to auto-play,
an indication of whether or not auto-play is to be silent,
an indication of whether or not to loop,
a start point within the video clip,
an end-point within the video clip, and/or
a degree of resizing.

2. The method of claim 1, wherein the controllable items of metadata, including at least one of the user-controlled items of metadata, further comprise metadata specifying one or more additional visual elements to be displayed in association with the playout of the video clip, the one or more additional visual elements comprising any one or more of:
a mask,
a border,
a thumbnail or other placeholder image for display prior to play-out,
a placeholder image for display prior to the thumbnail, and/or
call-to-action text.

3. The method of claim 1, wherein the controllable items of metadata, including at least one of the user-controlled items of metadata, further comprise metadata defining one or more rules specifying how the playout of the video clip is to be adapted in dependence on one or more conditions to be evaluated at the second user terminal.

4. The method of claim 3, wherein the one or more conditions comprise: a quality and/or type of network connection used by the second user terminal to receive the video clip.

5. The method of claim 1, wherein the determination of the video clip comprises receiving a user selection from the end-user selecting the video clip.

6. The method of claim 5, wherein the video clip is selected from amongst a plurality of other video clips stored on a content storage service operated by a provider of the video messaging service, and said communication of the selected video clip by the video message is performed by including in the message a link to the video clip as stored in the content storage service, rather than explicitly including the video clip in the video message.

7. The method of claim 1, wherein a configuration service stores a respective pre-specified values for each of a centrally-controlled one, some or all said controllable items of metadata for supply to the second terminal, to thereby control the playout.

8. The method of claim 7, wherein the pre-specified values are specified by a provider of the video messaging service, and supplied from the configuration service to the second user terminal under control of the provider.

9. The method of claim 8, wherein for at least one of the controllable items of metadata:
the respective user-specified value controls the playout by default if no respective provided-specified value is supplied by the configuration service, but otherwise the respective provider-specified value overrides the user-specified value.

10. The method of claim 8, wherein for at least one of the controllable items of metadata:
the respective provider-specified value controls the playout if no respective user-specified value is communicated in the video message, but otherwise the respective user-specified value overrides the provider-specified value.

11. The method of claim 8, wherein:
the determination of the video clip comprises receiving a user selection from the end-user selecting the video clip, from amongst a plurality of other video clips stored on a content storage service operated by the provider of the video messaging service, said communication of the selected video clip by the video message being performed by including in the message a link to the video clip as stored in the content storage service; and
the content storage service and the configuration service act as two separate provider-side tools, at least in that a different group of personnel is authorised to login to the configuration service to edit the provider-specified values of the metadata than is authorized to login to the content storage service to manage the video clips including said video clip.

12. The method of claim 8, wherein for each of one or more of the centrally-controlled items of metadata, the configuration service stores a different variant of the respective provider-specified value for different geographic regions or other groups of end users, said supply comprising supplying one of the variants to the second user terminal in dependence on which geographic region the second user terminal is in or which group a user of the second user terminal is in.

13. The method of claim 7, wherein for each of one or more of the centrally-controlled items of metadata, the configuration service stores a plurality of respective pre-set values; and said communication of at least one of the user-specified values by the video message is performed by including in the message a link to one of the respective pre-set values in the configuration service.

14. The method of claim 6, wherein said communication of at least one of the user-specified values by the video message is performed by including in the message a link to a value stored in to the content storage service.

15. The method of claim 1, wherein at least one of the user specified values is included explicitly in the video message.

16. The method of claim 8, wherein
the determination of the video clip comprises receiving a user selection from the end-user selecting the video clip, from amongst a plurality of other video clips stored on a content storage service operated by a provider of the video messaging service, said communication of the selected video clip by the video message being performed by including in the message a link to the video clip as stored in the content storage service; and
the configuration service enables the provider-specified values of the metadata to be varied independently of the video clips in the content storage service including said video clip.

17. The method of claim 8, wherein:
the determination of the video clip comprises receiving a user selection from the end-user selecting the video clip, from amongst a plurality of other video clips stored on a content storage service operated by a provider of the video messaging service, said communication of the selected video clip by the video message being performed by including in the message a link to the video clip as stored in the content storage service; and
at least one of the provider-specified values of the metadata in the configuration service varies over time while the video clip remains constant in the content storage.

18. The method of claim 17, wherein the metadata is seasonal.

19. A first user terminal comprising:
a user interface for receiving a user selection from an end-user of the first user terminal, selecting a respective user-selected value for each of a user-controlled one or more of a plurality of controllable items of metadata for controlling playout of the video clip when played out at the second user terminal;
a network interface; and
a controller configured to determine a video clip to be communicated to a second user terminal, and to uses a video messaging service to send a video message to a second user terminal over a network via said network interface, the video message communicating the video clip and the respective user-selected values for the one or more user-controlled items of metadata, thereby causing the second user terminal to play out the video clip in accordance with said one or more user-controlled items of metadata;
wherein the controllable items of metadata, including at least one of the one or more user-controlled items of metadata, comprise any one or more of:
an indication of whether or not to auto-play,
an indication of whether or not auto-play is to be silent,
an indication of whether or not to loop,
a start point within the video clip,
an end-point within the video clip, and/or
a degree of resizing.

20. A communication client application embodied on a computer-readable storage medium and configured so as when run on a first user terminal to perform operations of:
determining a video clip to be communicated to a second user terminal;
receiving a user selection from an end-user of the first user terminal, selecting a respective user-selected value for each of a user-controlled one or more of a plurality of controllable items of metadata for controlling playout of the video clip when played out at the second user terminal; and
using a video messaging service to send a video message over a network to a second user terminal, the video message communicating the video clip and the respective user-selected values for the one or more user-controlled items of metadata, thereby causing the second user terminal to play out the video clip in accordance with said one or more user-controlled items of metadata;
wherein the controllable items of metadata, including at least one of the one or more user-controlled items of metadata, comprise any one or more of:
an indication of whether or not to auto-play,
an indication of whether or not auto-play is to be silent,
an indication of whether or not to loop,
a start point within the video clip,
an end-point within the video clip, and/or
a degree of resizing.
